(19) United States
(12) Patent Application Publication
(10) Pub. No.: US 2026/0008714 A1
(43) Pub. Date: Jan. 8, 2026

(54) OPTICAL FIBER DRAWING APPARATUS AND METHOD OF MANUFACTURING OPTICAL FIBER

(71) Applicant: SUMITOMO ELECTRIC INDUSTRIES, LTD., Osaka (JP)

(72) Inventor: Kazuhiro YONEZAWA, Tochigi (JP)

(21) Appl. No.: 19/254,664

(22) Filed: Jun. 30, 2025

(30) Foreign Application Priority Data
Jul. 5, 2024 (JP) 2024-109003

(51) Int. Cl. C03B 37/02; C03B 37/025

(52) U.S. Cl. CPC C03B 37/0216; C03B 37/0253; C03B 2205/40

(57) ABSTRACT

An optical fiber drawing apparatus includes a drawing furnace configured to heat and soften an optical fiber base material and configured to draw the optical fiber, a capstan configured to pull and transport the optical fiber, a winding device configured to wind the optical fiber, a tensioning mechanism arranged between the capstan and the winding device and configured to test a strength of the optical fiber by tensioning the optical fiber, and a backup winding device arranged between the capstan and the tensioning mechanism and configured to temporarily wind the optical fiber when the optical fiber is broken.

### CROSS-REFERENCE TO RELATED APPLICATIONS

This application is based on and claims priority under 35 USC 119 from Japanese Patent Application No. 2024-109003 filed on July 5, 2024, the entire content of which is incorporated herein by reference.

### TECHNICAL FIELD

The present disclosure relates to an apparatus for drawing an optical fiber and a method for manufacturing an optical fiber.

### BACKGROUND ART

JP2003-519792A discloses a method and an apparatus for drawing an optical fiber while tensile-screening the optical fiber. From JP2003-519792A, a technique is disclosed, in which, when the optical fiber is broken in a tensile-screening device, a suction device is activated at a first position, moves in two dimensions, and then sucks and captures the optical fiber to guide the optical fiber to a predetermined component thereof, thereby performing threading of the optical fiber.

In JP2012-053066A, a configuration is disclosed, in which tensile-screening is performed during drawing of the optical fiber and if the optical fiber is broken, the optical fiber is guided back to a predetermined component to perform threading of the optical fiber. In JP2012-053066A, a technique is disclosed, in which a suction device sucks and captures the optical fiber and then moves in two dimensions, thereby moving the optical fiber to a second position.

In a case of drawing the optical fiber while tensile-screening the optical fiber, a tension applied to the optical fiber during tensile-screening is greater than a tension applied to the optical fiber during drawing. As a result, the optical fiber may be broken in the tensile- screening device. If the optical fiber is broken, threading of the optical fiber must be performed after drawing of the optical fiber has been stopped temporarily or a drawing speed of the optical fiber has been slowed down significantly. For this reason, a time required to again draw and tensile-screen the optical fiber (hereafter, referred to as a returning time) is increased.

JP2003-519792A and JP2012-053066A performs threading by capturing the broken optical fiber using the suction device and then moving the suction device or rollers to guide the optical fiber to the tensile-screening device. In this case, however, the suction device must continue to suck the optical fiber until threading of the optical fiber is completed. The returning time is relatively long, for example, 10 seconds (see the paragraph [0011 ] in JP2003-519792A). Also, if the drawing speed of the optical fiber is high, such as 2000 mn/min to 3000 mn/min, the suction device must suck a large amount of optical fiber. Therefore, the suction device is likely not to entirely suck the optical fiber.

### SUMMARY OF INVENTION

Aspect of non-limiting embodiments of the present disclosure relates to provide an apparatus for drawing an optical fiber and a method for manufacturing an optical fiber, which allow a reduced returning time even if the optical fiber is broken, and can perform drawing and screening of the optical fiber at a high speed.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an optical fiber drawing apparatus including: a drawing furnace configured to heat and soften an optical fiber base material and configured to draw the optical fiber; a capstan configured to pull and transport the optical fiber; a winding device configured to wind the optical fiber; a tensioning mechanism arranged between the capstan and the winding device and configured to test a strength of the optical fiber by tensioning the optical fiber; and a backup winding device arranged between the capstan and the tensioning mechanism and configured to temporarily wind the optical fiber when the optical fiber is broken.

According to an aspect of the present disclosure, there is provided a method of manufacturing an optical fiber by an optical fiber drawing apparatus, the drawing apparatus including: a drawing furnace configured to heat and soften an optical fiber base material and configured to draw the optical fiber; a capstan configured to pull and transport the optical fiber; a winding device configured to wind the optical fiber; a tensioning mechanism arranged between the capstan and the winding device and configured to test a strength of the optical fiber by tensioning the optical fiber; and a backup winding device arranged between the capstan and the tensioning mechanism and configured to temporarily wind the optical fiber when the optical fiber is broken, the method including: when the optical fiber is broken downstream of the capstan, winding the optical fiber by the backup winding device while pulling and transporting the optical fiber by the capstan.

### BRIEF DESCRIPTION OF DRAWINGS

Exemplary embodiment(s) of the present invention will be described in detail based on the following figures, wherein:

FIG. 1is a schematic view showing a configuration of an optical fiber drawing apparatus according to the present embodiment;

FIG. 2is a schematic view explaining a backup winding device of the drawing apparatus;

FIG. 3 is a schematic view showing a configuration of a claw portion of the backup winding device;

FIG. 4 is a schematic view explaining operation of the backup winding device during a normal state;

FIG. 5 is a schematic view explaining operation of the backup winding device as broken;

FIG. 6 is a schematic view illustrating an example of a returning procedure after being broken; and

FIG. 7 is a schematic view illustrating an example of a returning procedure after being broken.

### DESCRIPTION OF EMBODIMENTS

### (Description of Aspects of the Present Disclosure)

First, aspects of the present disclosure will be listed and described.

(1) A drawing apparatus for an optical fiber according to one aspect of the present disclosure includes a drawing furnace configured to heat and soften an optical fiber base material and configured to draw the optical fiber; a capstan configured to pull and transport the optical fiber; a winding device configured to wind the optical fiber; a tensioning mechanism arranged between the capstan and the winding device and configured to test a strength of the optical fiber by tensioning the optical fiber; and a backup winding device arranged between the capstan and the tensioning mechanism and configured to temporarily wind the optical fiber when the optical fiber is broken.

According to the present disclosure, the backup winding device for temporarily winding the broken optical fiber is provided between the capstan and the tensioning mechanism. Even if the optical fiber which is being drawn at a high speed is broken, the broken optical fiber can be wound around the backup winding device, thereby allowing threading to be performed while winding the optical fiber around the backup winding device at a high speed. Thus, the returning time can be shortened.

(2) The drawing apparatus according to the above (1) may further include a suction device arranged between the backup winding device and the tensioning mechanism and configured to suck the optical fiber when the optical fiber is broken. According to the present disclosure, the suction device for sucking the broken optical fiber is provided between the backup winding device and the tensioning mechanism. The broken optical fiber can be captured by the suction device, thereby ensuring that the captured optical fiber can be reliably wound around the backup winding device.

Also, once the optical fiber is wound around the backup winding device, the suction device does not need to continue to suck the optical fiber. In other words, the suction device needs to suck the optical fiber only until the optical fiber is wound around the backup winding device, and thus does not need to continue to suck the optical fiber until threading of the optical fiber is completed, thereby avoiding a situation that the suction device cannot entirely suck the optical fiber.

(3) In the drawing apparatus according to the above (2), the backup winding device may include: a shaft configured to wind the optical fiber; a first flange configured to be rotated together with the shaft; and a claw portion formed on an inner peripheral surface of the first flange and configured to catch the optical fiber, and the claw portion is positioned such that, as the first flange rotates, the claw portion is configured to traverse a pass line for the optical fiber, the pass line connecting a transport position at which the optical fiber is transported by the capstan and a suction inlet of the suction device.

According to the present disclosure, the optical fiber is sucked by the suction device, captured by the claw portion, and then wound around the shaft. Therefore, it is possible to start winding the optical fiber around the shaft immediately after the optical fiber is broken.

(4) A method of manufacturing an optical fiber by an optical fiber drawing apparatus, the drawing apparatus may includes: a drawing furnace configured to heat and soften an optical fiber base material and configured to draw the optical fiber; a capstan configured to pull and transport the optical fiber; a winding device configured to wind the optical fiber; a tensioning mechanism arranged between the capstan and the winding device and configured to test a strength of the optical fiber by tensioning the optical fiber; and a backup winding device arranged between the capstan and the tensioning mechanism and configured to temporarily wind the optical fiber when the optical fiber is broken, the method comprising: when the optical fiber is broken downstream of the capstan, winding the optical fiber by the backup winding device while pulling and transporting the optical fiber by the capstan.

According to the present disclosure, the optical fiber is wound by the backup winding device while the capstan pulls and transports the optical fiber. Therefore, even if the drawing speed of the optical fiber is high, it is possible to thread the optical fiber while winding the optical fiber around the backup winding device. Thus, the returning time can be shortened.

(5) In the method according to the above (4), the drawing apparatus may further include a suction device arranged between the backup winding device and the tensioning mechanism and configured to suck the optical fiber, the method further comprises: when the optical fiber is broken downstream of the capstan, sucking and capturing the optical fiber by the suction device, and winding the optical fiber by the backup winding device.

According to the present disclosure, the optical fiber is sucked and captured by the suction device and then wound by the backup winding device. Therefore, the optical fiber captured by the suction device can be reliably wound around the backup winding device.

### (Detailed Description of Embodiments of the Present Disclosure)

Specific examples of an optical fiber drawing apparatus according to embodiments of the present disclosure will be described with reference to the accompanying drawings. Meanwhile, the present invention is not limited to these examples, but is defined by the appending claims and also intended to encompass all modifications falling within the meaning and scope equivalent to the scope of the claims.

### (Optical Fiber Drawing Apparatus)

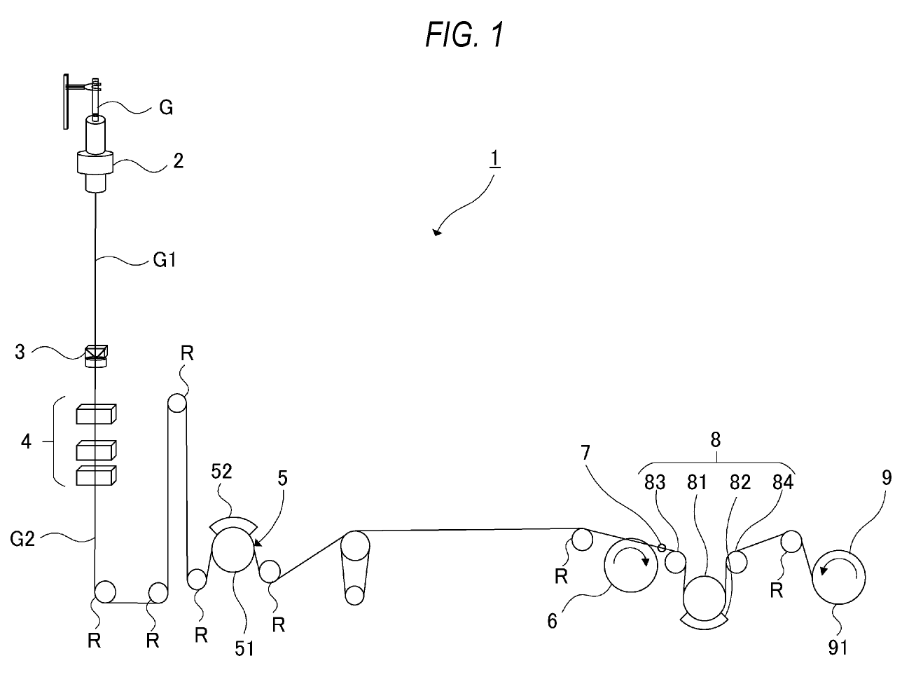

FIG. 1 is a schematic view showing a configuration of an optical fiber drawing apparatus 1 according to the present embodiment. The optical fiber drawing apparatus 1 is configured to form a glass fiber G1 by drawing an optical fiber base material G and to cover an outer periphery of the glass fiber G1 with resin, thereby manufacturing an optical fiber G2. The optical fiber base material G is an optical fiber base material including quartz glass as a main component, for example.

The optical fiber drawing apparatus 1 includes a drawing furnace 2, a resin applying device 3, a resin curing device 4, a capstan 5, a backup winding device 6, a suction device 7, a tensioning mechanism 8, and a winding device 9.

The drawing furnace 2 is configured to heat and soften a lower end of the optical fiber base material G. The optical fiber base material G is inserted into the drawing furnace 2. The lower end of the optical fiber base material G, which is softened by heating, is pulled downward and stretched thin, thereby drawing the glass fiber G1.

The resin applying device 3 and the resin curing device 4 are arranged downstream of the drawing furnace 2 in a traveling direction of the glass fiber G1 (downward direction in FIG. 1 ). Resin is applied around the glass fiber G1 by the resin applying device 3, and the resin is cured by the resin curing device 4. Thus, the optical fiber G2, in which the resin is formed around the glass fiber G1, is formed.

The capstan 5 is configured to pull and transport the optical fiber G2. The capstan 5 includes a capstan roller 51 and a capstan belt 52. The capstan belt 52 is provided to come in contact with a part of an outer peripheral surface of the capstan roller 51. As the capstan roller 51 rotates, the optical fiber G2 sandwiched between the outer peripheral surface of the capstan roller 51 and the capstan belt 52 is pulled and transported downstream. A tension applied to the optical fiber G2 by the capstan 5 is a tension for drawing the optical fiber G2 from the optical fiber base material G and transporting the optical fiber G2 to the winding device 9. A plurality of guide rollers R may be arranged between the resin curing device 4 and the capstan 5 or between the capstan 5 and the backup winding device 6.

The winding device 9 is configured to wind the optical fiber G2 transported from the capstan 5. The winding device 9 includes a single winding roller 91. As the winding roller 91 rotates, the optical fiber G2 is wound around an outer periphery of the winding roller 91.

The tensioning mechanism 8 is arranged between the capstan 5 and the winding device 9. The tensioning mechanism 8 is configured to test a strength of the optical fiber G2 by tensioning the optical fiber G2.

The tensioning mechanism 8 includes a main roller 81, a driven belt 82, an upstream roller 83 and a downstream roller 84. The driven belt 82 is provided to come in contact with a part of an outer peripheral surface of the main roller 81. As the main roller 81 rotates, the optical fiber G2 sandwiched between the outer peripheral surface of the main roller 81 and the driven belt 82 is pulled, thereby tensioning the optical fiber G2. A tension applied to the optical fiber G2 by the tensioning mechanism 8 is a tension for testing a strength of the optical fiber G2. The tension applied to the optical fiber G2 by the tensioning mechanism 8 is greater than the tension applied to the optical fiber G2 by the capstan 5.

The main roller 81 and the driven belt 82 are arranged between the upstream roller 83 and the downstream roller 84 and below both the upstream roller 83 and the downstream roller 84. The main roller 81 and the driven belt 82 may move upward or downward with respect to the upstream roller 83 and the downstream roller 84, thereby adjusting a tension applied to the optical fiber G2. By the tensioning mechanism 8 configured in this way, screening of the optical fiber G2 can be performed.

The backup winding device 6 is arranged between the capstan 5 and the tensioning mechanism 8. The backup winding device 6 is configured to temporarily wind the optical fiber G2 when the optical fiber G2 is broken. The backup winding device 6 has a higher winding effect when arranged closer to the tensioning mechanism 8. The backup winding device 6 is arranged, for example, upstream of the upstream roller 83 of the tensioning mechanism 8. The configuration and operation of the backup winding device 6 will be described below.

The suction device 7 is arranged between the backup winding device 6 and the tensioning mechanism 8. The suction device 7 is configured to suck the optical fiber G2 when the optical fiber G2 is broken. The suction device 7 is, for example, an aspirator which sucks and exhausts gas. The suction device 7 can increase a winding effect of the backup winding device 6 when arranged closer to the backup winding device 6.

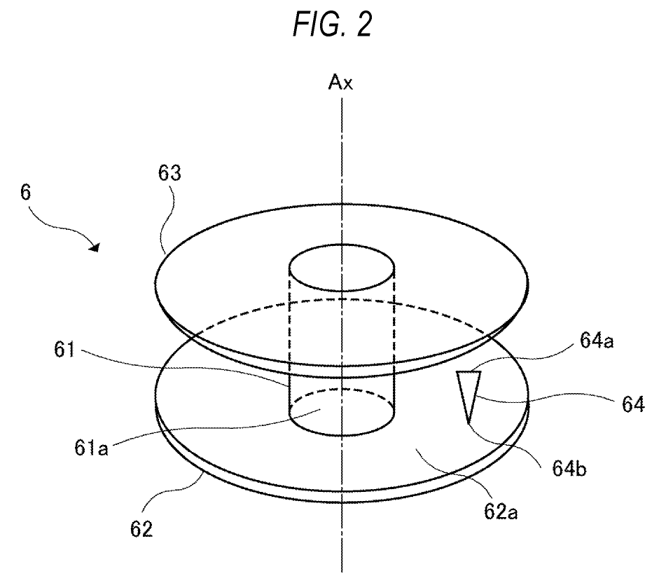

Next, the configuration of the backup winding device 6 will be described. FIG. 2 is a schematic view of the backup winding device 6. As shown in FIG. 2, the backup winding device 6 includes a shaft 61, a first flange 62, a second flange 63 and a claw portion 64.

The shaft 61 is configured to wind the optical fiber G2. The optical fiber G2 is wound around an outer peripheral surface 61 a of the shaft 61. The shaft 61 is configured to rotate about an axis Ax. As viewed in a plane perpendicular to the axis Ax, a cross-sectional shape of the shaft 61 is, for example, circular.

The first flange 62 and the second flange 63 are each provided at respective opposite ends of the shaft 61. The first flange 62 and the second flange 63 are configured to rotate together with the shaft 61. The first flange 62 and the second flange 63 are configured to prevent the optical fiber G2 from falling off the shaft 61. As viewed in a plane perpendicular to the axis Ax, a cross-sectional shape of the first flange 62 and a cross- sectional shape of the second flange 63 are, for example, circular. As viewed in a plane perpendicular to the axis Ax, a diameter of the first flange 62 is greater than a diameter of the shaft 61 and a diameter of the second flange 63 is greater than the diameter of the shaft 61.

The claws portion 64 is formed on an inner peripheral surface 62 a of the first flange 62. The claw portion 64 is configured to catch the optical fiber G2.

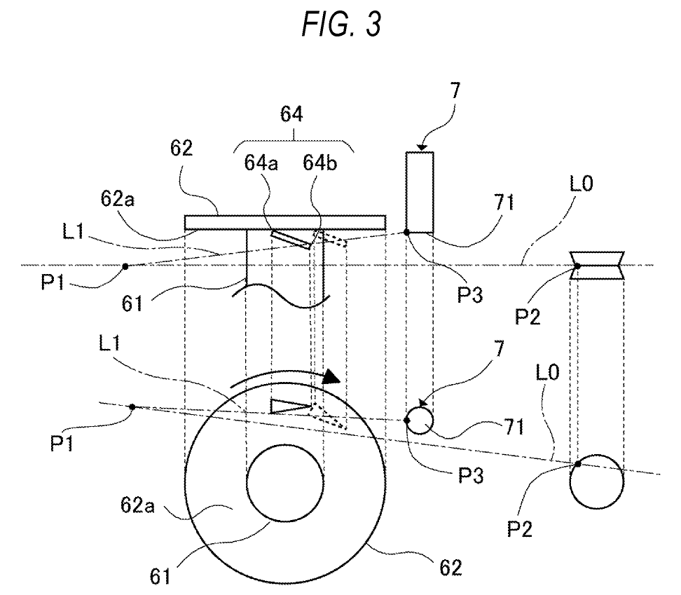

FIG. 3 is a schematic view explaining a configuration of the claw portion 64. The schematic view in shows the backup winding device 6 and the suction device 7 as viewed from the top and side. In order to explain the configuration of the claw portion 64,FIG. 3illustrates the backup winding device 6 (except the second flange 63), the suction device 7, and the upstream roller 83 of the tensioning mechanism 8.

In the following description, the term "normal" refers to a case where the optical fiber G2 is not broken and thus is normally being drawn and screened. The term "as-broken" refers to a case where the optical fiber G2 is broken downstream of the capstan 5.

In a normal state, the optical fiber G2 transported from the capstan 5 is being transported to the upstream roller 83 of the tensioning mechanism 8. More specifically, the optical fiber G2 passes through a normal pass line LO for the optical fiber G2 connecting between a transport position P1, which is located upstream of the backup winding device 6 and at which the optical fiber G2 is transported from the guide roller R immediately before the backup winding device 6, and a winding position P2 on the upstream roller 83. The normal pass line LO passes between the first flange 62 and the second flange 63 of the backup winding device 6 and also before a suction inlet 71 of the suction device 7.

FIG. 3 also shows an as-broken pass line L1 in addition to the normal pass line LO. The as-broken pass line L1 is a pass line connecting the transport position P1, at which the optical fiber G2 is transported from the capstan 5, and a suction position P3 on the suction inlet 71 of the suction device 7.

The transport position P1 is located upstream of the backup winding device 6 and corresponds to a position, at which in cases of both the normal state and the as-broken state, the optical fiber G2 is transported from the guide roller R immediately before the backup winding device 6. The transport position P1 is located on both the nonnal pass line LO and the as-broken pass line L1.

The winding position P2 is located close to the backup winding device 6 and corresponds to a position, at which the optical fiber G2 is in contact with the outer peripheral surface of the upstream roller 83 when the optical fiber G2 is being drawn normally without being broken.

The suction position P3 is a location on the suction inlet 71 of the suction device 7 which is closer to the backup winding device 6. Also, the suction position P 3 corresponds to a position, at which when the optical fiber G2 is broken downstream of the capstan 5, the broken optical fiber G2 is sucked and brought in contact with the suction inlet 71. The claw portion 64 according to the present embodiment is positioned such that as the first flange 62 rotates, the claw portion 64 can traverse the as-broken pass line L1 connecting the transport position P1 and the suction position P3.

The claws portion 64 has a flat plate shape and is provided to be inclined from the inner peripheral surface 62a of the first flange 62. The claw portion 64 is constructed, for example, by a triangular-shaped flat plate. A first side 64a of the triangular shape is provided to abut against the inner peripheral surface 62a of the first flange 62, and a vertex 64b opposite to the first side 64a is provided to be away from the inner peripheral surface 62a. The claw portion 64 is provided to be inclined relative to the inner peripheral surface 62a, so that the broken optical fiber G2 can be caught on the claw portion 64.

### (Method of Manufacturing Optical Fiber)

Next, the method of manufacturing an optical fiber by the drawing apparatus I will be described with reference to FIGS. 1, 4 and 5. The manufacturing method according to the present embodiment performs drawing the optical fiber G2 at a high speed and screening the optical fiber G2.

First, an optical fiber base material G is inserted into the drawing furnace 2. A lower end of the optical fiber base material G is heated and softened within the drawing furnace 2. A mass of glass softened by heating falls downward from the lower end of the optical fiber base material G by its own weight. The lump of glass fallen from the drawing furnace 2 is stretched and thinned to become a glass fiber G I having a predetermined glass diameter. The thinned glass fiber Gl passes through the resin applying device 3 and the resin curing device 4, thereby forming an optical fiber G2. The optical fiber G2 is pulled to the capstan 5 and transported to the tensioning mechanism 8. The drawing speed of the optical fiber G2 is, for example, from 2000 o/min to 3000 o/min. The optical fiber G2 is tensioned by the tensioning mechanism 8 to test a strength of the optical fiber G2, thereby performing screening of the optical fiber G2. Thereafter, the optical fiber G2 is wound around the winding device 9, thereby completing drawing (FIG. 1).

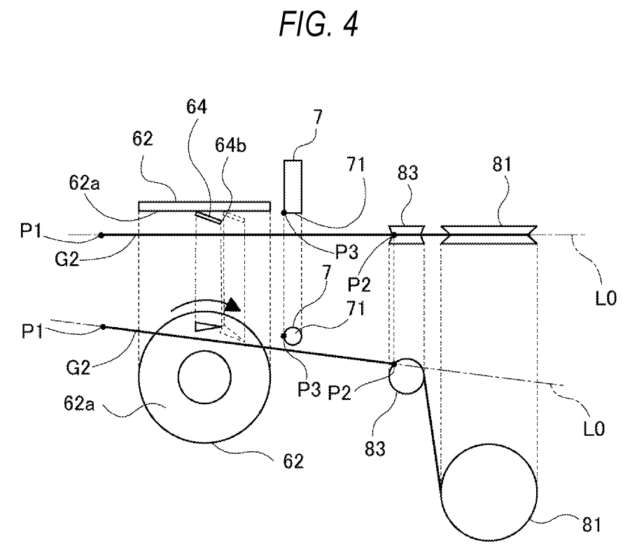

FIG. 4 is a schematic view explaining operation of the backup winding device 6 during a normal state. The schematic view in FIG. 4shows parts of the backup winding device 6, the suction device 7 and the tensioning mechanism 8 as viewed from the top and side. In FIG. 4, the shaft 61 and the second flange 63 of the backup winding device 6 are omitted in order to make it easier to see operation of the claw portion 64.

As shown in FIG. 4, during a normal state, the optical fiber G2 moves along the normal pass line LO to be transported to the upstream roller 83 of the tensioning mechanism 8 and then wound around the main roller 81. At this time, the optical fiber G2 passes between the first flange 62 and the second flange 63 of the backup winding device 6 and also before the suction inlet 71 of the suction device 7. Since the claw portion 64 formed on the inner peripheral surface 62a of the first flange 62 is positioned not to traverse the normal pass line LO, the optical fiber G2 can pass by the claw portion 64 without being caught thereon.

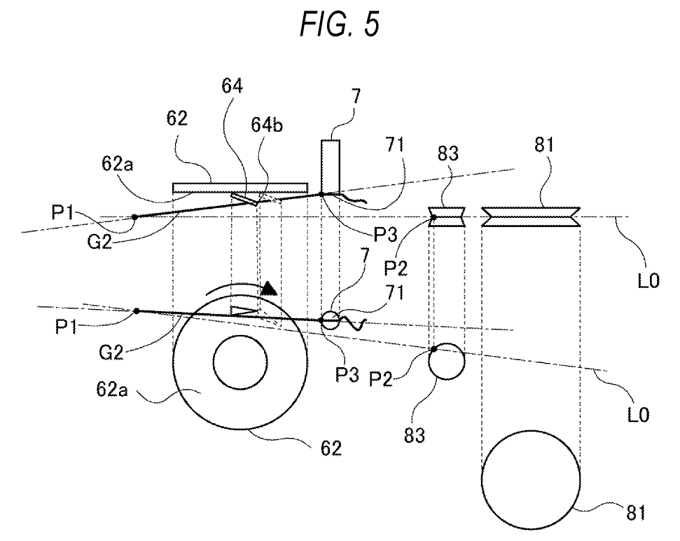

FIG. 5 is a schematic view explaining operation of the backup winding device 6 as broken. Among components shown in , the same components as the components shown in are designated by the same reference numerals and the descriptions thereof will be omitted.

Since the tensioning mechanism 8 applies a relatively high tension to the optical fiber G2 to test a strength of the optical fiber G2, there is a possibility that the optical fiber G2 is broken near the tensioning mechanism 8. FIG. 5 illustrates, as one example of an as-broken state, a case where the optical fiber G2 is broken between the suction device 7 and the upstream roller 83.

In the present embodiment, when the optical fiber G2 is broken downstream of the capstan 5, the suction device 7 sucks and captures the optical fiber G2. Since the suction inlet 71 of the suction device 7 is provided to be positioned toward the normal pass line LO, a part of the broken optical fiber G2 is drawn and captured by the suction inlet 71 of the suction device 7. The suction device 7 may always perform sucking even during the normal state and may start sucking after breaking of the optical fiber G2 is detected by a sensor (not shown).

When the broken optical fiber G2 is captured by the suction device 7, the end of the optical fiber G2 is fixed at the suction position P3. In this way, the broken optical fiber G2 reaches on the as-broken pass line L1. Since the claw portion 64 is positioned so that as the first flange 62 rotates, the claw portion 64 can traverse the as-broken pass line L1, the broken optical fiber G2 is caught on the claw portion 64. The first flange 62 may always rotate even during the normal state and may start rotating after breaking of the optical fiber G2 is detected by a sensor (not shown).

Even after the broken optical fiber G2 is caught on the claw portion 64, the first flange 62 continues to rotate. Even if the optical fiber G2 is broken, the capstan 5 pulls and transports the optical fiber G2 downstream, and as the first flange 62 continues to rotate, the broken optical fiber G2 is wound around the shaft 61. In this way, the broken optical fiber G2 is wound onto the backup winding device (6).

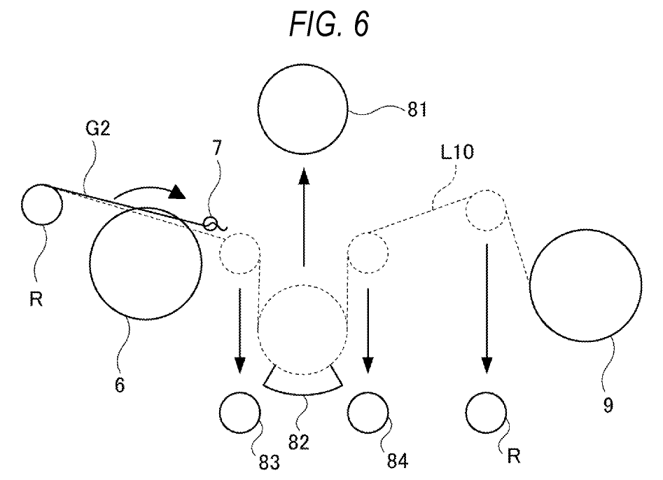

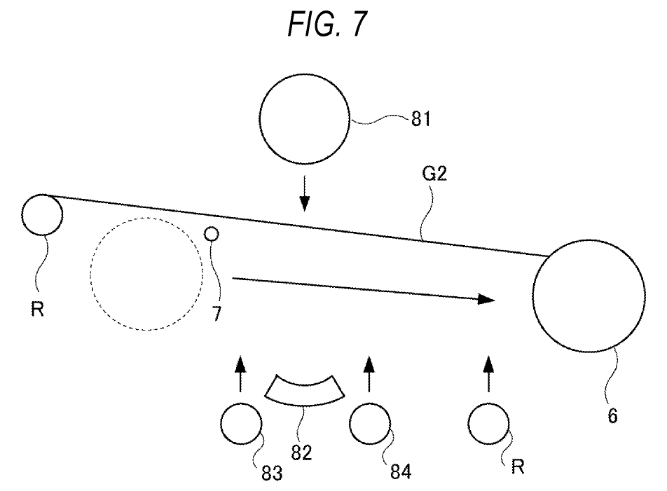

FIGS. 6 and 7 are schematic views illustrating an example of a returning procedure after broken. As shown in FIG. 6, as the backup winding device 6 continuous to wind the optical fiber G2, an operator moves rollers, which are positioned between the backup winding device 6 and the winding device 9, to be spaced away from a pass line L10, along which the optical fiber G2 passes from the capstan 5 to the winding device 9 during the normal state. For example, the operator can move the main roller 81 of the tensioning mechanism 8 upward and also the upstream roller 83 and the downstream roller 84 downward. If there is a guide roller R between the tensioning mechanism 8 and the winding device 9, the guide roller R is moved to be spaced away from the pass line L10. Also, the operator also detaches the winding device 9 from the drawing apparatus 1.

Even while the main roller 81 and the like are being moved or the winding device 9 is being detached, the optical fiber G2 is being wound by the backup winding device 6, thereby ensuring that the capstan 5 can continue to transport the optical fiber G2. The drawing speed of the optical fiber G2 and the winding speed of the backup winding device 6 may be kept at a high speed or temporarily slowed down.

Then, as shown in FIG. 7, the operator moves the backup winding device 6 to a location, where the winding device 9 was positioned. When the backup winding device 6 and the winding roller 91 have the same size, the backup winding device 6 may be positioned as a new winding roller 91 at the location, where the winding device 9 was positioned. Then, the operator moves the main roller 8l and the like, which were moved in FIG. 6, back to their original positions, and then performs threading of the optical fiber G2. After threading of the optical fiber G2 is completed, drawing and screening of the optical fiber is resumed.

As described above, according to the drawing apparatus 1 of the present embodiment, the backup winding device 6 is provided between the capstan 5 and the tensioning mechanism 8 for temporarily winding a broken optical fiber G2. Even if the drawn optical fiber G2 is broken, the optical fiber G2 can be wound around the backup winding device 6, thereby ensuring that threading of the optical fiber G2 can be performed while the optical fiber G2 is wound around the backup winding device 6.

The capstan 5 in the present embodiment transports the optical fiber G2 at a high drawing speed of 2000 m/min to 3000 n/min. Even if the drawing speed was such a high speed, the backup winding device 6 can also wind the optical fiber G2 at a similar speed. Therefore, even when the optical fiber G2 is broken, the capstan 5 does not need to stop transporting of the optical fiber G2. For this reason, an effect of the broken optical fiber G2 can hardly be propagated upstream of the backup winding device 6, and also the returning time can be shortened as compared to a case where the backup winding device 6 is not provided.

According to the drawing apparatus 1 of the present embodiment, the suction device 7 is provided between the backup winding device 6 and the tensioning mechanism 8 for sucking the broken optical fiber G2. Since the broken optical fiber G2 can be captured by the suction device 7, the end of the optical fiber G2 can be fixed to the suction inlet 71 of the suction device 7, and the fixed optical fiber G2 can be reliably wound around the backup winding device 6.

In addition, once the optical fiber G2 is wound around the backup winding device 6, the suction device 7 does not need to continue to suck the optical fiber G2. In other words, the suction device 7 needs to suck the optical fiber G2 only until winding of the optical fiber G2 by the backup winding device 6 is completed. Thus, the suction device 7 does not need to continue to suck the optical fiber G2 until threading is completed. For this reason, even if the drawing speed was high, it is possible to avoid the situation that the suction device 7 cannot suck the optical fiber G2.

According to the drawing apparatus 1 of the present embodiment, the claw portion 64 is positioned such that as the first flange 62 rotates, the claw portion 64 can traverse the as- broken pass line L1 connecting the transport position P1 and the suction position P3. Since the optical fiber G2 is caught by the claw portion 64 and wound around the shaft 61, winding of the optical fiber G2 around the shaft 61 can be started immediately after the optical fiber G2 is broken.

According to the manufacturing method of the present embodiment, even if an optical fiber G2 is broken, the optical fiber G2 is wound around the backup winding device 6, while the capstan 5 pulls and transports the optical fiber G2. For this reason, even if the drawing speed of the optical fiber is high, it is possible to thread the optical fiber G2 while winding the optical fiber G2 around the reserve winding device 6. Thus, the returning time can be shortened.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The optical fiber G2 wound around the backup winding device 6 may be left wound around the backup winding device 6 as an unscreened optical fiber. After winding of the optical fiber G2 by the backup winding device 6 is ended, the optical fiber G2 wound around the backup winding device 6 may be screened by another screening device (not shown).

What is claimed is:

1. An optical fiber drawing apparatus comprising:
a drawing furnace configured to heat and soften an optical fiber base material and configured to draw the optical fiber; a capstan configured to pull and transport the optical fiber; a winding device configured to wind the optical fiber; a tensioning mechanism arranged between the capstan and the winding device and configured to test a strength of the optical fiber by tensioning the optical fiber; and a backup winding device arranged between the capstan and the tensioning mechanism and configured to temporarily wind the optical fiber when the optical fiber is broken.

2. The optical fiber drawing apparatus according to claim 1, further comprising:
a suction device arranged between the backup winding device and the tensioning mechanism and configured to suck the optical fiber when the optical fiber is broken.

3. The optical fiber drawing apparatus according to claim 2, wherein the backup winding device includes:
a shaft configured to wind the optical fiber; a first flange configured to be rotated together with the shaft; and a claw portion formed on an inner peripheral surface of the first flange and configured to catch the optical fiber, and the claw portion is positioned such that, as the first flange rotates, the claw portion is configured to traverse a pass line for the optical fiber, the pass line connecting a transport position at which the optical fiber is transported by the capstan and a suction inlet of the suction device.

4. A method of manufacturing an optical fiber by an optical fiber drawing apparatus, the drawing apparatus including:
a drawing furnace configured to heat and soften an optical fiber base material and configured to draw the optical fiber; a capstan configured to pull and transport the optical fiber; a winding device configured to wind the optical fiber; a tensioning mechanism arranged between the capstan and the winding device and configured to test a strength of the optical fiber by tensioning the optical fiber; and a backup winding device arranged between the capstan and the tensioning mechanism and configured to temporarily wind the optical fiber when the optical fiber is broken, the method comprising: when the optical fiber is broken downstream of the capstan, winding the optical fiber by the backup winding device while pulling and transporting the optical fiber by the capstan.

5. The method according to claim 4, wherein the drawing apparatus further includes a suction device arranged between the backup winding device and the tensioning mechanism and configured to suck the optical fiber, the method further comprises: when the optical fiber is broken downstream of the capstan, sucking and capturing the optical fiber by the suction device, and winding the optical fiber by the backup winding device.
